(19) United States
(12) Patent Application Publication
(10) Pub. No.: US 2003/0093758 A1
(43) Pub. Date: May 15, 2003

(54) Visual job ticketing using a document viewing application

(75) Inventors: Carl Michael Dennison, Longmont, CO (US); Ronald L. Heiney, Longmont, CO (US); Richard J. Howarth, Boulder, CO (US); Brian William Moroney, Longmont, CO (US); Dwight Ross Palmer, Longmont, CO (US); Adam A. Swartz, Thornton, CO (US); John Stuart Walker, Boulder, CO (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/065,527

(22) Filed: Oct. 25, 2002

Related U.S. Application Data
(60) Provisional application No. 60/357,806, filed on Oct. 26, 2001.

(51) Int. Cl. G06F 15/00

(52) U.S. Cl. 715/513

(57) ABSTRACT

A standard document viewing application, such as Adobe Acrobat Exchange, Microsoft Word or others, is used with plug in enhancements to display a document to be printed and visual feedback cues associated with user selected print job parameters. The job originator then has all the advantages of the viewing application when ticketing the job, such as thumbnail drag-and-drop and other manipulations, zoom, multiple-page display, multiple documents open simultaneously, document content editing and adjustment, bookmarks and other document navigation aids. In addition, the job originator can use a familiar interface to view documents without having to learn a new application.

### CROSS REFERENCE TO RELATED APPLICATIONS

This application claims priority from Provisional Application Serial No. 60/357,806 filed 26 Oct. 2001.

### BACKGROUND OF THE INVENTION

The present invention relates to the field of modern, high-feature printers. More specifically, the invention relates to the intuitive and simple observation and manipulation of print job parameters (including page exceptions).

Today, when preparing jobs for printing on high-feature printers, such as the IBM Infoprint 2000 and others, the job originator may specify many different job ticketing parameters. Many of these parameters are best described visually. These parameters include such features as choice of media, ordered media sets (such as precut tab stock), one-sided or two-sided printing, force-to-front-side printing, preprinted inserts, document covers, tape binding, stapling, hole drilling, and so on. Some parameters apply to the entire document (document attributes); others apply only to certain pages within the document (page exceptions).

Typically, existing products require that the job originator specify these parameters using traditional dialogs and selecting the page numbers for page exceptions. In such an environment, it is easy for the job originator to make a mistake because there is no visual feedback identifying exactly what document attributes were set or which pages have exceptions. Some existing products use a proprietary document viewing application to show a visual image of each page in the document with some visual indications of the current document attributes and page exceptions. The usability and flexibility of such proprietary applications is limited and, by definition, require that the user learn a new application interface.

What is needed in the field is a high-function printer which allows the user to utilize a known, standard document viewing application to display a print job and to view and modify the selected print job parameters. Ideally, the standard document viewing application would display selected print job parameters and allow such parameters to be manipulated from within the application.

### SUMMARY OF INVENTION

It is a purpose of the present invention to improve over existing products by using a standard document viewing application, such as Adobe Acrobat Exchange, Microsoft Word or others, to display the document and the visual feedback cues associated with the currently selected print job parameters. The job originator then has all the advantages of the viewing application when ticketing the job, such as thumbnail drag-and-drop and other manipulations, zoom, multiple-page display, multiple documents open simultaneously, document content editing and adjustment, bookmarks and other document navigation aids. In addition, the job originator can use a familiar interface to view documents without having to learn a new application.

In realizing this purpose, the present invention comprises a set of plug-ins to an existing, standard document viewing application, to let job originators specify job ticket parameters for the entire document and for individual pages and page groups. The plug-ins also display visual cues in the document to provide feedback to the job originator about which parameters have been set. The specific set of visual cues used in this invention is the subject of a related disclosure and will not be elaborated here. However, it will be obvious to one skilled in the art that the present invention could be implemented using any set of visual cues associated with print job ticketing parameters.

### BRIEF DESCRIPTION OF DRAWINGS

Some of the purposes of the invention having been stated, others will appear as the description proceeds, when taken in connection with the accompanying drawings, in which:

FIG. 1 is a schematic representation of an information handling system and associated printer in which the present invention is implemented.

FIG. 2 is a schematic representation of one exemplary display generated during exercise of the present invention.

FIG. 3 is a schematic representation of the steps of the method of the present invention, in flowchart form.

FIG. 4 is an illustration of a computer readable medium bearing program instructions effective when executing to implement the present invention.

### DETAILED DESCRIPTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

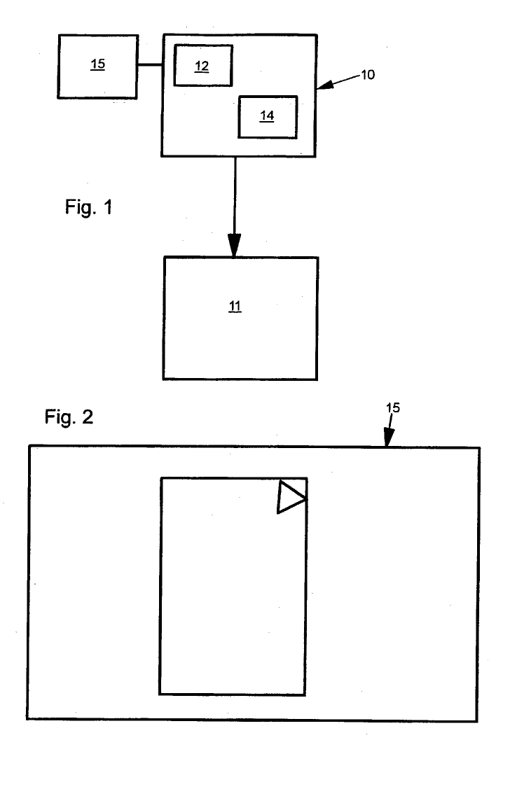

Referring now to FIG. 1, an information handling system implementing the present invention is there shown at 10 with an associated high feature printer 11. The system 10 has a processor 12, associated memory 14, and a display 15. Appropriate operator manipulated input devices such as a keyboard or pointing device are provided as well known in the applicable arts, but are not illustrated as being well known. By using the input devices, an operator may cause the system 10 to retrieve and execute programs and operate on data files which may be stored in the memory 14 or otherwise be accessible to the processor 12 as through a network, from a removable disk or the like.

When executing with a document viewing application program as described above, the plug-ins of the present invention insert visual feedback directly into the source document (for example, adding a dog-ear corner to the upper right page corner to show duplex printing, see FIG. 2), so any user interactions in the source document apply to the visual feedback as well. For example, as the user moves pages around in the document, the visual feedback moves with the page automatically. When the visual cues are added to the document, the plug-ins keep track of the objects to which they have added themselves and which were in the document originally. Preferably, the plug-ins add a hidden or unseen marker to the visual cue objects, but alternatively the plug-ins could keep a list of visual cue object IDs. When the document is to be saved or printed, the plug-ins search each page for visual cue objects and remove them, so that the saved or printed document does not include the cues. For example, dog-ear corners are very useful when editing the job ticket in the application, but are not desirable in the printed output document. The job ticket parameters represented by the visual cues are stored or printed via the job ticket instead.

Visual cues for document attributes (those which apply to the entire document, such as stapling or hole drilling) are applied to every page in the source document (for example, as by showing on the display a darkened line in a corner, or circles appropriately positioned in a margin of a page). Visual cues for page exceptions (such as choosing blue paper for certain pages) are applied only to the affected page (such s by coloring that page view). These cues are also reflected in the thumbnail view of the document (if the application supports such a view) so that job originators can see many pages at once and easily identify which pages have exceptions associated with them. Existing products do not support a thumbnail view and require the originator to page through all document pages to see the visual cues full size.

The plug-ins of this invention monitor the user's commands to the application, such as page moves, insertions, deletions, document switching, document close, document open, and so on so they can adjust the job ticket representation according to the user's actions. The plug-ins can, subject to application limitations, restrict user actions to those that are compatible with job ticketing.

The plug-ins of this invention monitor the user's current page selection (for example, via the thumbnail view) and apply job ticketing page exceptions to the selected pages. The plug-ins can, subject to application limitations, adjust the selection as needed to be compatible with job ticketing. The plug-ins can also adjust the enabled job ticketing actions to be compatible with the current selection. Existing products do not support thumbnails of the page data for selection, but use other non-visual methods, such as a ‘tree-view’ of the document.

The plug-ins of this invention extend the application's user interface (for example, by adding new menu items and dialogs) to let the user invoke job ticketing functions. Some new functions needed for job ticketing are:

Create new ticket.

Open existing ticket.

Import existing ticket.

Export ticket.

Delete ticket.

Switch ctive tickett.

Create/Modify document attributes.

Create/Modify age exceptions┘.

Print Job with Ticket Parameters.

Show/Hide Visual Cues.

Job Ticketing Help.

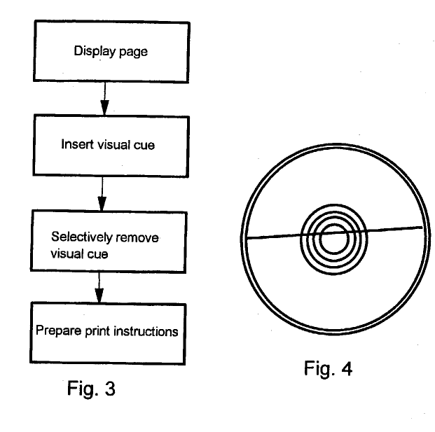

FIG. 3 illustrates schematically the sequence which is implemented in practice of the present invention.

Program instructions implementing the present invention as here described and shown may be distributed on computer readable media such as the disc shown in FIG. 4 and, when executing on a processor, will follow the steps shown in FIG. 3.

In the drawings and specifications there has been set forth a preferred embodiment of the invention and, although specific terms are used, the description thus given uses terminology in a generic and descriptive sense only and not for purposes of limitation.

1. A method comprising:
displaying a plurality of original document visual objects of an original document;
inserting into the original document a plurality of visual cue objects corresponding to print job ticketing parameters, thereby creating an amended document, and displaying the plurality of visual cue objects; and
removing from the amended document, for specific operations to be performed on the amended document, at least one of the plurality of visual cue objects and performing the specific operations.

2. The method of claim 1 wherein the specific operation is a save operation.

3. The method of claim 1 wherein the specific operation is a print operation.

4. The method of claim 1 wherein said step of inserting further includes inserting an unseen marker with each of the plurality of visual cue objects and wherein said step of removing the at least one of the plurality of visual cue objects further includes locating the unseen marker.

5. The method of claim 1 wherein said step of inserting further includes maintaining a list of each of the plurality of visual cue objects inserted and wherein said step of removing the at least one of the plurality of visual cue objects further includes referencing the list and identifying the at least one of the plurality of visual cue objects to be removed.

6. The method of claim 1 wherein said steps of inserting and removing are performed by a plug-in to a document editor providing a plug-in interface.

7. The method of claim 6 wherein the plug-in is further effective in performing the step of:
applying certain of the print job ticketing parameters to all pages of the document.

8. The method of claim 6 wherein the plug-in is further effective in performing the step of:
applying certain of the print job ticketing parameters to selected pages of the document.

9. A program product comprising:
a computer readable medium;
program instructions on said medium which, when executing on a processors, are effective to:
display a plurality of original document visual objects of an original document;
insert into the original document a plurality of visual cue objects corresponding to print job ticketing parameters, thereby creating an amended document, and display the plurality of visual cue objects; and
remove from the amended document, for specific operations to be performed on the amended document, at least one of the plurality of visual cue objects and performing the specific operations.

10. The product of claim 9 wherein the specific operation is a save operation.

11. The product of claim 9 wherein the specific operation is a print operation.

12. The product of claim 9 wherein said insertion further includes inserting an unseen marker with each of the plurality of visual cue objects and wherein said removal of the at least one of the plurality of visual cue objects further includes locating the unseen marker.

13. The product of claim 9 wherein said insertion further includes maintaining a list of each of the plurality of visual cue objects inserted and wherein said removal of the at least one of the plurality of visual cue objects further includes referencing the list and identifying the at least one of the plurality of visual cue objects to be removed.

14. The product of claim 9 wherein said insertion and removal are performed by a plug-in to a document editor providing a plug-in interface.

15. The product of claim 14 wherein the plug-in is further effective to apply certain of the print job ticketing parameters to all pages of the document.

16. The product of claim 14 wherein the plug-in is further effective to apply certain of the print job ticketing parameters to selected pages of the document.
